(19) United States
(12) Patent Application Publication
(10) Pub. No.: US 2008/0189346 A1
(43) Pub. Date: Aug. 7, 2008

(54) METHOD FOR REALIZING FINITE FIELD DIVIDER ARCHITECTURE

(76) Inventors: Jau-Yet WU, Fongshan City (TW); Hsie-Chia Chang, Hsinchu City (TW)

Correspondence Address: SINORICA, LLC, 528 FALLSGROVE DRIVE, ROCKVILLE, MD, 20850, US

(21) Appl. No.: 11/780,090

(22) Filed: Jul. 19, 2007

(30) Foreign Application Priority Data
Feb. 6, 2007 (TW) 96104248

(51) Int. Cl. G06F 7/38; H04K 1/00

(52) U.S. Cl. 708/492; 380/28

(57) ABSTRACT

A method for realizing a finite field divider architecture is proposed, in which all standard basis of a divider are transformed into the composite field basis, and the circuit is realized using subfield multiplier, squarer, adder and lookup table over this composite field. The user can finish a division operation within one clock cycle and accomplish the requirement of low complexity. In many finite field operations, divider circuits like this are very helpful to RS/BCH decoders or ECC/Security processors.

### BACKGROUND OF THE INVENTION

1. Field of the invention

The present invention relates to a divider and, more particularly, to a method for realizing a finite field divider architecture.

2. Description of Related art

Nowadays, many digital electronic products such as digital television satellite broadcaster, USB flash disk and hard disk will certainly make use of finite field operations. Some common finite field operations include BCH/RS code, AES code, Ellipse Curve code, and ECC/code processor. These codes are widely used in many applications such as high-speed DVB-S2 and DVB-S1, storage device like flash memory and hard disk, and system houses and the IC/IP design industry related to ECC/Security embedded processor. In related finite field operations for decoding RS/BCH code or AES code, a finite field divider was hard to realize in the past due to hardware difficulties. Therefore, the algorithm of a finite-field related system is conventionally changed to another algorithm without division or inverse. The result of avoiding division is that the number of operation cycles will be much larger than that of algorithms supporting division (e.g., critical polynomial and error decoding circuit of BCH/RS decoder). Since processor-based designs are the trend of the future, if an instruction set of division operation can be customized for finite-field related processors, the advantage of design can be greatly enhanced.

In the prior art, there were many papers concerning parallel inversion over the finite field, but few articles and inventions concerning bit-parallel division operation over the finite field. The inversion methods include:
(1) Using the Fermat's theorem to achieve inversion within m clock cycles. The drawback is that several clock cycles are required for inversion. If the functionality of division is required, it is necessary to add a multiplier at rear end, which will result in a total period of (m+1) clock cycles.
(2) Using a brute-force lookup table cascaded with a multiplier to achieve inversion, the drawback is that the area would be too large. When the number of bits (m) is smaller than or equal to 8, the lookup table is about the same as a 2 variable multiplier of identical number of bits. However, when m is larger than 9, the hardware complexity of the lookup table will be very high. For instance, when m=10. the gate count is about 4.2 k. If applied to DVB-S2 BCH decoder systems over GF(2¹⁶) and GF(2¹⁴), the lookup table cannot be synthesized out at all.
(3) Using the composite field to achieve Rijndale inversion. This method can transform the inversion operation into the subfield to accomplish low complexity, but its functionalities is not as attractive as the divider.

Accordingly, the present invention aims to propose a method designed in the composite field to realize a low-complexity divider requiring only a single clock cycle.

### SUMMARY OF THE INVENTION

An object of the present invention is to provide a method for realizing a finite field divider architecture. The method comprises the steps of: transforming all standard basis of division operation with higher bits into a plurality of composite field basis with lower bits; using a plurality of operation units (e.g., lookup table, square, 2 constant multiplier, constant multiplier) with shorter data paths to finish a critical path to replace the division operation with long data path; and then transforming the result into the standard basis. The operation and hardware complexity can therefore be greatly reduced, and this process can be carried out within a single clock cycle. The proposed method can reduce the area of a division operation with high number of bits to very small. Moreover, the critical path used is the same as that obtained by using inversion in the composite field.

### BRIEF DESCRIPTION OF THE DRAWINGS

The various objects and advantages of the present invention will be more readily understood from the following detailed description when read in conjunction with the appended drawing, in which:

FIG. 1 is a diagram of a 10-bit divider.

### DETAILED DESCRIPTION OF THE PREFERRED EMBODIMENTS

The present invention provides a method for realizing a finite field divider architecture, in which standard basis are transformed into the composite field domain, and a plurality of operation units with shorter data paths is used to finish a division operation with a longer data path, and the result is transformed into the standard basis to finish a divider.

The composite field is a type of extension field. Its ground field (GF) is defined over GF(2ⁿ) instead of GF(2). A preferred embodiment is illustrated below. If α belongs to GF((2²)²), α can be represented as α=a₁x+a₀, where a₁ and a₀ belong to GF(2²), e.g., α={10}x+{11}. If α belongs to GF((2³)³), α can be represented as α=a₂x²+a₁x+a₀, where a₂, a₁ and a₀ belong to GF(2³), e.g., α=={110}x²+{011}x+{100}. The rest may be deduced by analogy. The idea of the present invention is to transform finite field arithmetic over the standard basis into this composite field domain and then transform the result back into the standard basis after division operation. The proposed method can apply to BCH/RS decoder or finite-field related applications. For instance, divisions are common operations in solving critical polynomial or in the Forney algorithm of BCH/RS decoder.

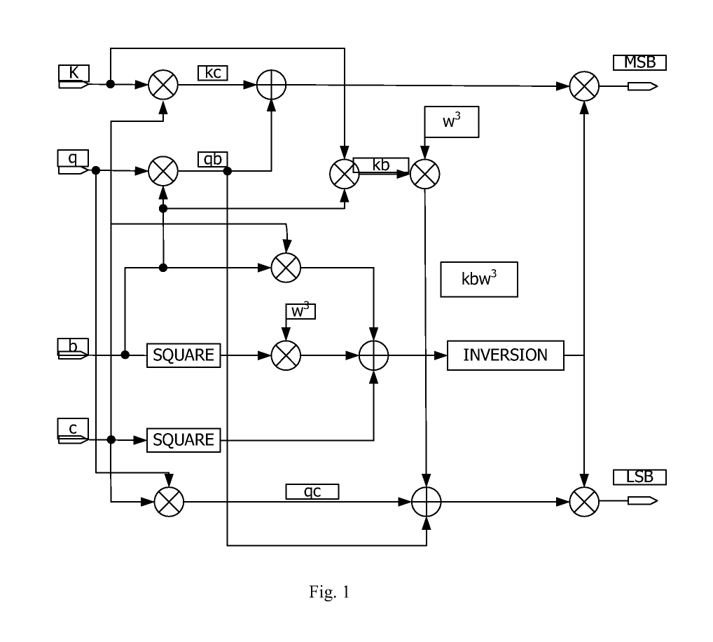

An embodiment used in a 10-bit divider of a Reed Solomon decoder is described below to illustrate how to achieve a division operation. In the present invention, a 10-bit standard basis is transformed into two 5-bit composite basis to reduce the complexity, and operation units with smaller data paths (m=5) like 2 variable multiplier, constant multiplier, adder, inversion table, squarer are used to finish the algorithm and circuit. The critical path of the present invention is the same as that obtained by inversion in the composite field. Moreover, the action of looking up inversion table is performed over the subfield. For instance, the critical path can be 2 subfield multipliers +adder (1 XOR)+subfield LUT (lookup table). The following example is an operation of dividing (kx+q) by (bx+c). As shown in FIG. 1, assuming kx+q and bx+c have first been transformed into the composite field, the algorithm of (kx+q)/(bx+c) is as follows:

$$\begin{matrix}\frac{kx + q}{bx + c} = ( kx + q ) [ {b ( {b}^{2} {w}^{3} + bc + {c}^{2} )}^{- 1} + ( b + c ) {( {b}^{2} {w}^{3} + bc + {c}^{2} )}^{- 1} ] \\ = {( {b}^{2} {w}^{3} + bc + {c}^{2} )}^{- 1} ( bx + b + c ) ( kx + q ) \\ = {( {b}^{2} {w}^{3} + bc + {c}^{2} )}^{- 1} ( {kbx}^{2} + kbx + kcx + qbx + qb + qc ) \\ = {( {b}^{2} {w}^{3} + bc + {c}^{2} )}^{- 1} ( kb ( x + {w}^{3} ) + kbx + kcx + qbx + qb + qc ) \\ = {( {b}^{2} {w}^{3} + bc + {c}^{2} )}^{- 1} ( {kbw}^{3} + kcx + qbx + qb + qc ) \\ = {( {b}^{2} {w}^{3} + bc + {c}^{2} )}^{- 1} ( ( kc + qb ) x + {kbw}^{3} + qb + qc )\end{matrix}$$

In the above algorithm, the primitive polynomial for GF(2⁵) is x⁵+x²+1, the primitive polynomial for GF(2¹⁰) is x¹⁰+x³+1, and the monic primitive polynomial for GF((2⁵)²) is x²+x2+w³, (w³ denoted 01000, where w is the primitive root with respect to GF(2⁵). With this algorithm, a 10-bit finite field divider can be synthesized to operate at 180 MHz with gate count 1K for the 0.18 μm process, about 2 variable multipliers of identical width and also having a low complexity. Moreover, the whole procedure is finished within one single clock cycle. Therefore, the method of the present invention is very attractive for applications related to finite field operations.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A method for realizing a finite field divider architecture comprising the steps of:
transforming all standard basis of division operation with more bits into a plurality of composite field basis with less bits;
using a plurality of operation units with shorter data paths over said composite field to finish a critical path and replace said division operation with a longer data path; and
transforming result into the standard basis to complete a divider.

2. The method as claimed in claim 1, wherein said operation units include inversion table, squarer, 2 variable multiplier, and constant multiplier.

3. The method as claimed in claim 2, wherein action of looking up the inversion table is performed over subfield.

4. The method as claimed in claim 1, wherein said division is accomplished within a single clock cycle.

5. The method as claimed in claim 1, wherein said critical path is same as that obtained by inversion in the composite field.

6. The method as claimed in claim 1, wherein said composite field is a type of extension field.

7. The method as claimed in claim 1, wherein said composite field is defined over GF(2ⁿ).

8. The method as claimed in claim 1, wherein said divider is used by RS/BCH decoders or ECC/Security processors.
